(19) United States
(12) Patent Application Publication
(10) Pub. No.: US 2011/0042261 A1
(43) Pub. Date: Feb. 24, 2011

(54) Nano or sub-nano FIR and anion fuel tank for motor vehicle and the like

(76) Inventor: Yixin Guo, Ronkonkoma, NY (US)

Correspondence Address: Jinggao Li, 560 Black Rock Tpke, Fairfield, CT, 06825, US

(21) Appl. No.: 12/583,476

(22) Filed: Aug. 21, 2009

(51) Int. Cl. B60K 15/03; B65D 85/00

(52) U.S. Cl. 206/524.3; 206/524.6

(57) ABSTRACT

A fuel tank, which is made from general, nanoized or sub-nanoized plastic or metal materials and can be used for motor vehicles and ships, includes a nano or sub-nano Far Infrared Ray (FIR) and anion carrier. The structures of the carrier are made up of nano or sub-nano tourmaline granules integrated into general, nano or sub-nano rubber, resin, plastic, or metal materials. The carrier can be the whole body of the tank, patch, block, stick, paste, liner, or shell set on the tank. The carrier can reach a far infrared emission rate up to 96% from 85% by general tourmaline materials and facilitate sufficient combustion by breaking fuel molecular group into pieces. As a result, the novel tank can achieve an extra 12-percent fuel economy improvement. The percentage of toxic gas in the exhaust will be correspondingly reduced.

### FIELD OF THE INVENTION

This invention describes a plastic or metal fuel tank with different embodiments that can be applied to vehicles and ships' gasoline or diesel engines. It is a distinct fuel tank with a nano or sub-nano FIR and anion carrier. The body of fuel tank itself is made from general, nano or sub-nano plastic or metal materials, and the carrier is made up of nano or sub-nano FIR and anion granules integrated into the body of the carrier made from general, nano or sub-nano rubber, resin, plastic, or metal materials. The fuel tank can make fuel bum efficiently, and it can also reduce the emission of toxic exhaust such as carbon dioxide.

### BACKGROUND OF THE INVENTION

As the demand for petroleum soars, to fix the issues of both high cost of petroleum and the exhausted emissions from the devices consuming petroleum become challenges for the society. Usually the fuel tank is only designed for fuel storage. Because of the above issues, the tank is expected to work as a storage device and a fuel economizer simultaneously. There are two different types of fuel economizers in the market, that is, economizers with either outer circle model or joint model. The principle of a fuel economizer is: when fuel is flowing to the fuel economizers, fuel economizer magnetizes fuel molecules. The fact that carbon and oxygen have opposite magnetic polarity induces that both carbon and oxygen are easily fused together producing a better and efficient combustion. As a result of the fusion of fuel and air, the engine works more efficiently generating greater power, reducing the consumption of fuel, and also the hydrocarbons (HC), carbon monoxide (CO) and nitrogen oxide which emanate from the exhaust. The limitations of these two models of fuel economizers include: 1. Two models of fuel economizers can be installed only after customers bought the vehicles or ships, which is very inconvenient for both customers and manufacturers. 2. For the outer circle model and the joint model fuel economizers, there are technical problems with the installation. For example, for the joint model, in order to install the fuel economizer, the transmitting pipe connecting with the fuel tank is needed to be severed. 3. The high-polarity magnetic field and/or the FIR can activate the fuel only when the fuel actively moves in the fuel economizer. Because of the above limitations of the existing economizers, it is desired to have a more effective fuel economizer to overcome these above shortcomings and achieve the target of fuel saving.

### BRIEF SUMMARY OF THE INVENTION

The invention presents a plastic or metal fuel tank effective for fuel saving and beneficial for environment protection. The detailed descriptions of the invention are: a FIR anion fuel tank is applied to vehicles and ships. The said fuel tank comprises a tank body made from general, nano or sub-nano plastic or metal materials and a carrier. The structures of the carrier, also named as FIR and anion carrier, are made up of nano or sub-nano tourmaline or tourmaline and germanium ore granules integrated into the carrier body made from general, nano or sub-nano materials, that is, the carrier consists of two parts: 1. nano or sub-nano granules for the purpose of FIR and anion; these granules are around 5˜20% in weight; 2. the left 80˜95% materials in weight, called as the carrier body, is made from general, nano or sub-nano materials that can be rubber, resin, plastic or metal. The granules and carrier body are mixed together to form the carrier. Embodiments of the present invention are described in more detail below with reference to the accompanying drawings, that is, a fuel tank that is made from general, nano or sub-nano plastic or metal materials includes a carrier,
1. The structures of the said carrier are made up of nano or sub-nano FIR and anion granules and the said carrier is the whole body of the said tank. The carrier body is general, nano, or sub-nano plastic or metal materials.
2. The structures of the said carrier are patches or blocks made up of nano or sub-nano FIR and anion granules and the said carrier is merged in the whole body of the said tank. The carrier body is general, nano, or sub-nano plastic or rubber materials.
3. The structures of the said carrier are sticks made up of nano or sub-nano FIR and anion granules and the said carrier is sticked to the interior or exterior wall of the said tank. The carrier body is general, nano, or sub-nano plastic or rubber materials.
4. The structures of the said carrier are pastes made up of nano or sub-nano FIR and anion granules and the said carriers is pasted to the inner or outer wall surface of the said tank. The carrier body is general, nano, or sub-nano resin materials.
5. The structures of the carrier are liners made up of nano or sub-nano FIR and anion granules and the said carrier is the interior wall of the said tank. The carrier body is general, nano, or sub-nano plastic or metal materials.
6. The structures of the carrier are shell structures made up of nano or sub-nano FIR and anion granules and the said carrier is the exterior wall of the said tank. The carrier body is general, nano, or sub-nano plastic or metal materials.

### DESCRIPTION OF THE DRAWINGS

FIG. 1 is a three-dimensional view of a nano or sub-nano fuel tank for vehicles and ships;

FIG. 2 is a side view of invention embodiments as stated in the above 1: a nano or sub-nano fuel tank for vehicles and ships. The carrier is the whole body of the tank.

FIG. 3 is a side view of invention embodiments as stated in the above 2: The structures of the said carrier are patches or blocks made up of nano or sub-nano FIR and anion granules and the said carrier is merged in the whole body of the tank.

FIGS. 4 and 5 are side views of invention embodiments as stated in the above 3. The structures of the said carrier are sticks made up of nano or sub-nano FIR and anion granules and the said carrier is sticked to the interior or exterior wall of the tank.

FIGS. 6 and 7 are side views of invention embodiments as stated in the above 4: The structures of the said carrier are pastes made up of nano or sub-nano FIR and anion granules and the said carrier is pasted to the interior wall of the tank.

FIG. 8 is a side view of invention embodiments as stated in the above 5: The structures of the carrier are liners made up of nano or sub-nano FIR and anion granules and the said carrier is the interior wall of the tank.

FIG. 9 is a side view of invention embodiments as stated in the above 6: The structures of the carrier are shell structures made up of nano or sub-nano FIR and anion granules and the said carrier is the exterior wall of the tank.

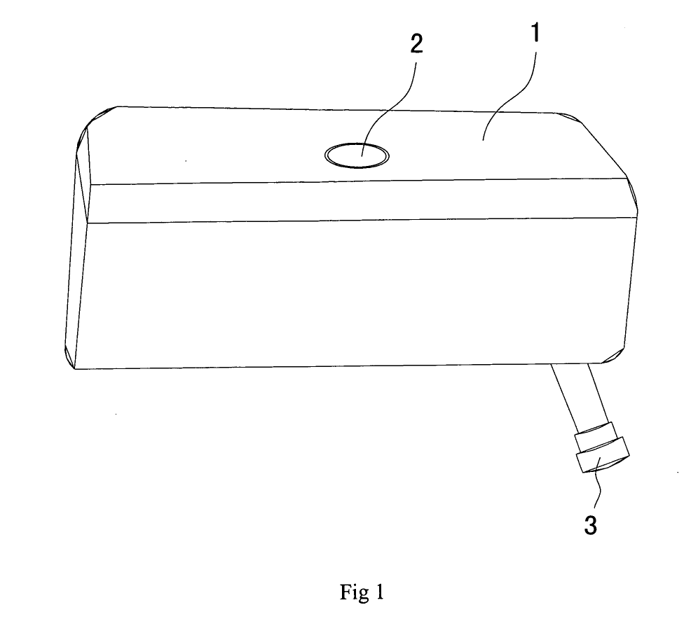

### DETAILED DESCRIPTION OF THE INVENTION

The terms and contents in the above descriptions are explained as follows:
1) In the above descriptions, “Nano or sub-nano fuel tank for vehicles and ships” means a fuel tank made from general, nano or sub-nano plastic or metal including a nano or sub-nano FIR and anion carrier that can be applied to the internal combustion engines of vehicles and ships.
2) In the above descriptions, “nano or sub-nano tourmaline ore granules” can generate FIR and anion, and “nano or sub-nano germanium ore granules” mainly generates anions. Other materials that can generate anions include, but are not limited to: Gui gems, Shenzhou stones and tourmaline. These anion materials can be used either separately or with two or more combined.
3) In the above descriptions, the carrier comprises two parts: nano or sub-nano FIR and anion granules and a carrier body made from general, nano or sub-nano rubber, resin, plastic or metal materials. These two are mixed with each other, and the mixture is called as the carrier. In the structures of carrier, 5-20% in weight is nano or sub-nano tourmaline or tourmaline and germanium granule materials and the left 80˜95% in weight is the carrier body. The structures of the carrier can be the whole body of the tank, patch, block, stick, paste, liner, or shell carriers set on the tank.
4) Nano tourmaline ore granules have FIR and the emission rate up to 96%, which is higher than what regular tourmaline ore granules can generate. Nano germanium ore granules can generate more anions than regular germanium ore granules.
5) Sub-nano tourmaline ore granules have a FIR and the emission rate up to 92%, which is higher than what regular tourmaline ore granules can generate. Sub-nano germanium ore granules can generate more anions than regular germanium ore granules.
6) The fuel tank container body is made up of general, nano or sub-nano plastic or metal materials.
7) When the structures of the carrier are the whole body of the tank, liners, or shell structures, the carrier body is made from general, nano, or sub-nano plastic or metal materials.
8) When the structures of the carrier are the patches, blocks, or sticks, the carrier body is made from general, nano, or sub-nano plastic or rubber materials.
9) When the structures of the carrier are pastes, the carrier body is made from general, nano, or sub-nano resin materials.
10) Size of nano granules is from 1 nm to 100 nm.
11) Size of sub-nano granules is from 101 nm to 999 nm.

The principle of the present invention is: when the fuel stays in FIR anion fuel tank that can be used for vehicles and ships, the carrier of the tank emits FIR and anion. This emission directly acts upon the fuel. When the van der Waals force between fuel molecules is destroyed by the emission of FIR and anion, long-chain molecules become single molecules and/or short-chain molecules. Therefore the average distances between molecules increases and fuel molecules have more space free to move. As a result, burning efficiency of the fuel will be improved greatly and the exhausted toxic gases will drop correspondingly. Based on the above theory, this present invention of FIR and anion fuel tank for vehicles and ships has the following advantages over tanks with existing non-nanoized FIR and anion technologies:
1. The present invention of nano or sub-nano FIR anion fuel tank for vehicles and ships itself is a very good fuel economizer besides its fuel storage and transportation. Nano or sub-nano FIR anion fuel tank can save up to 12% more fuels than what non-nano FIR fuel economizers in the market can save;
2. The present invention of nano or sub-nano FIR anion fuel tank for vehicles and ships emits FIR and anions. This emission rate is increased up to 96% from ˜85% by a tank without nanoized or sub-nano granules. This unexpected emission rate can provide a higher efficiency in fuel saving for nano or sub-nano FIR anion tank.

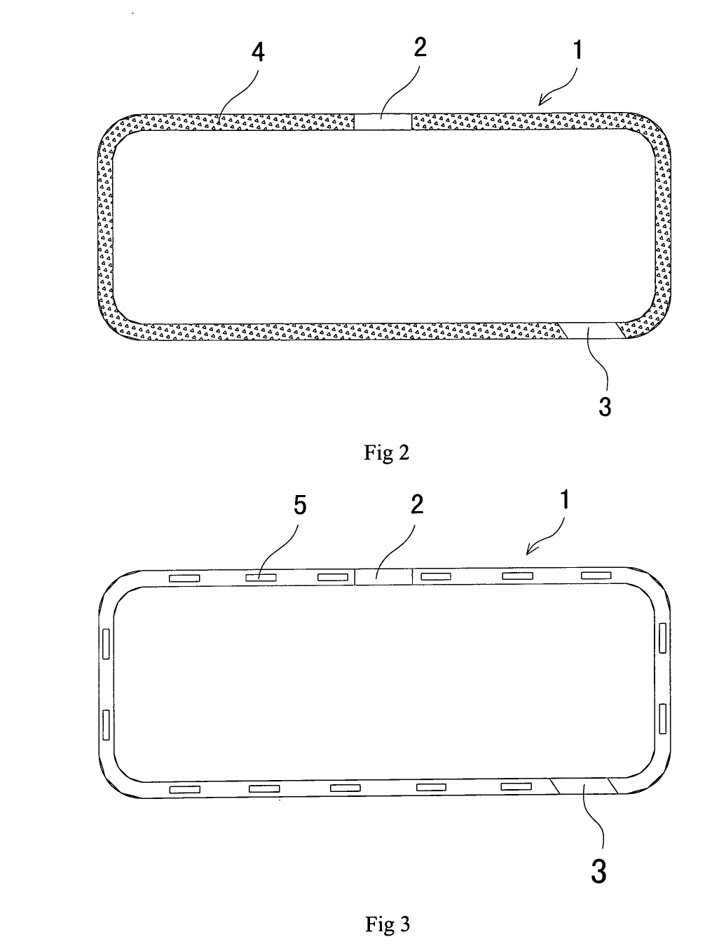

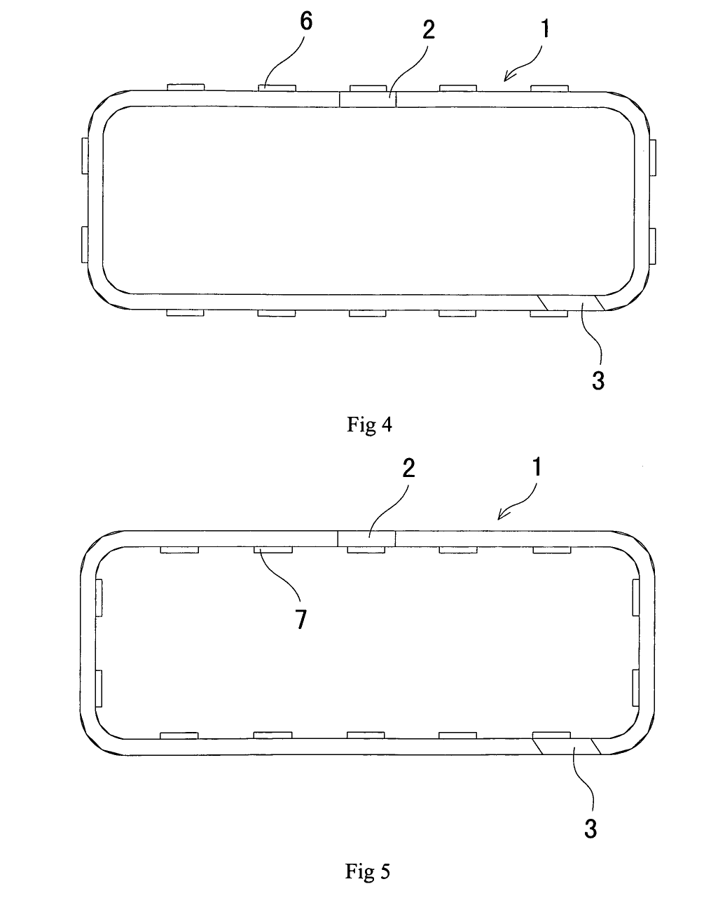

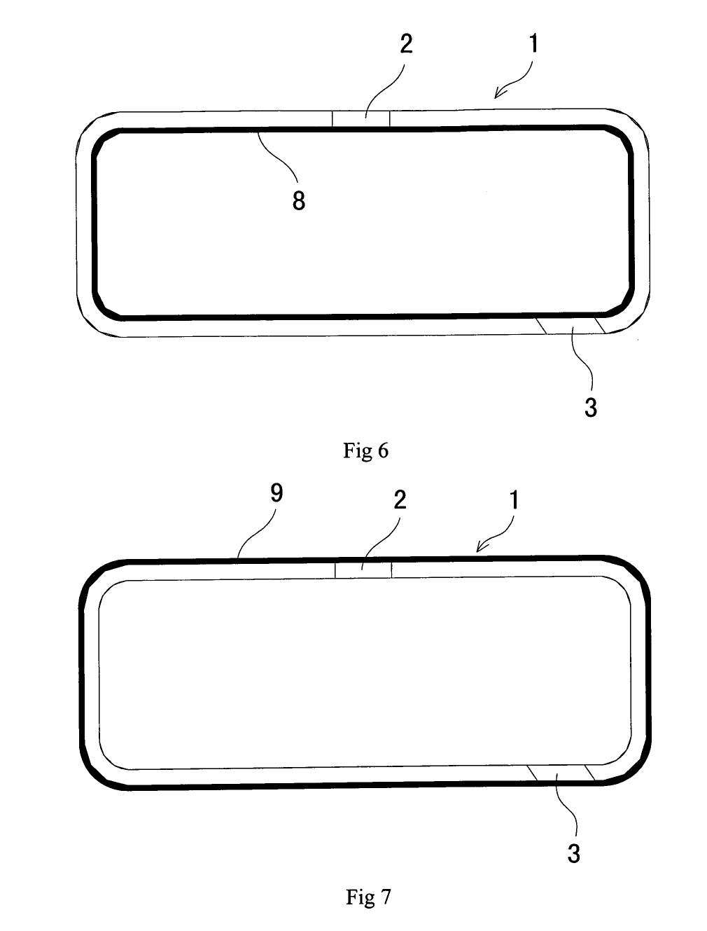

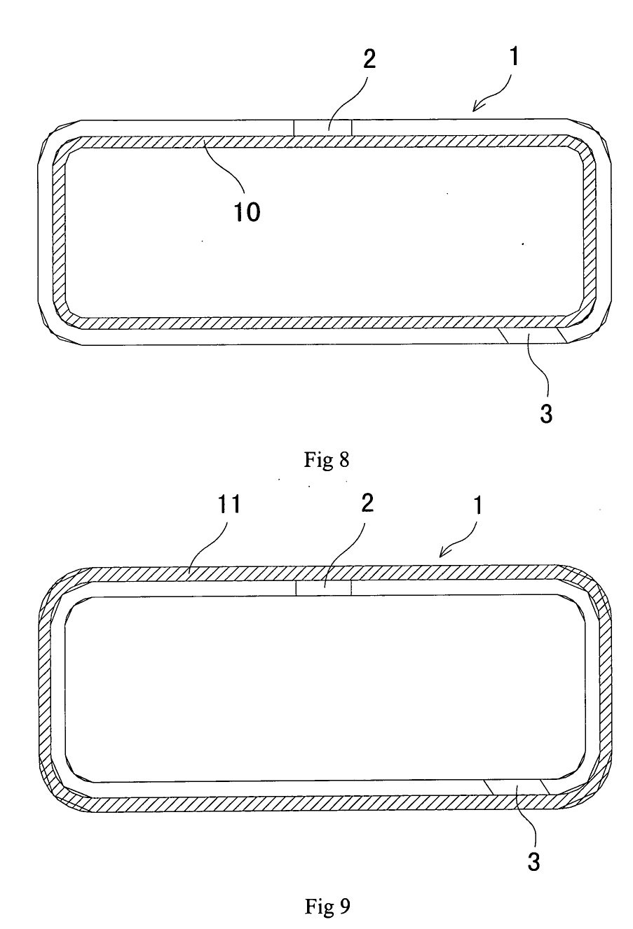

The present invention has been illustrated with demonstrated samples. Embodiments of the present invention are: a nano or sub-nano FIR anion fuel plastic tank for vehicles and ship comprises a tank body 1, fuel inlet 2, and fuel outlet 3. Label 4˜label 11 are for different structures of the carrier. Detailed embodiments are described as follows:
1. The carrier labeled as 4 in FIG. 2 is the whole body of the tank with nano or sub-nano FIR and anion granules;
2. The carrier labeled as 5 in FIG. 3 is a carrier with patches or blocks made up of nano or sub-nano FIR and anion granule, and the said carrier is merged in the whole body of the tank;
3. The carrier labeled as 6 in FIG. 4 is a carrier with stick structures made up of nano or sub-nano FIR and anion granules, and the said carrier is sticked to the exterior wall of the tank;
4. The carrier labeled as 7 in FIG. 5 is a carrier with stick structures made up of nano or sub-nano FIR and anion granules, and the said carrier is sticked to the interior wall of the tank;
5. The carrier labeled as 8 in FIG. 6 is paste made up of nano or sub-nano FIR and anion granules, and the said carrier is pasted to the inner wall surface of the tank;
6. The carrier labeled as 9 in FIG. 7 is paste made up of nano or sub-nano FIR and anion granules, and the said carrier is pasted to the outer wall surface of the tank;
7. The carrier labeled as 10 in FIG. 8 is a carrier with liner structures made up of nano or sub-nano FIR and anion granules, and the said carrier is the interior wall of the tank;
8. The carrier labeled as 11 in FIG. 9 is a carrier with shell structures made up of nano or sub-nano FIR and anion granules, and the said carrier is the exterior wall of the tank.

1. A plastic or metal fuel tank for vehicles and ships, comprising a tank body made from general, nano, or sub-nano plastic or metal materials and a nano or sub-nano far infrared ray (FIR) and anion carrier, wherein the structures of the carrier are made up of nano or sub-nano tourmaline granules or tourmaline and germanium ore granule materials integrated into the body of the said carrier.

2. A plastic or metal fuel tank according to claim 1, wherein the structures of the said carriers are made up of nano or sub-nano FIR and anion granules and the said carrier is the whole body of the said tank.

3. A plastic or metal fuel tank according to claim 1, wherein the structures of the said carrier are patches or blocks made up of nano or sub-nano FIR and anion granules and the said carrier is merged in the whole body of the said tank.

4. A plastic or metal fuel tank according to claim 1, wherein the structures of the said carrier are sticks made up of nano or sub-nano FIR and anion granules and the said carrier is sticked to the interior or exterior wall of the said tank.

5. A plastic or metal fuel tank according to claim 1, wherein the structures of the said carrier are pastes made up of nano or sub-nano FIR and anion granules and the said carrier is pasted to the inner or outer wall surface of the said tank.

6. A plastic or metal fuel tank according to claim 1, wherein the structures of the carrier are liners made up of nano or sub-nano FIR and anion granules and the said carrier is the interior wall of the said tank.

7. A plastic or metal fuel tank according to claim 1, wherein the structures of the carrier are shell structures made up of nano or sub-nano FIR and anion granules and the said carrier is the exterior wall of the said tank.

8. A plastic or metal fuel tank according to claims 2, 6 and 7, wherein the body of the said carrier is made from general, nano or sub-nano plastic or metal materials.

9. A plastic or metal fuel tank according to claims 3 and 4, wherein the body of the said carrier is made from general, nano or sub-nano plastic or rubber materials.

10. A plastic or metal fuel tank according to claim 5, wherein the body of the said carrier is made from general, nano or sub-nano resin materials.
